(19) United States
(12) Patent Application Publication
(10) Pub. No.: US 2013/0093816 A1
(43) Pub. Date: Apr. 18, 2013

(54) SYSTEM FOR ADJUSTING THE BASE OF THE PRINT HEAD OF A PLOTTER

(71) Applicants: Antoni Balsells Mercadé, Key Biscayne, FL (US); Francesc Masgrau Lagresa, Banyoles-Girona (ES); Antoni Guimerá Pedrola, Sant Sadurni D'anoia-Barcelona (ES)

(72) Inventors: Antoni Balsells Mercadé, Key Biscayne, FL (US); Francesc Masgrau Lagresa, Banyoles-Girona (ES); Antoni Guimerá Pedrola, Sant Sadurni D'anoia-Barcelona (ES)

(21) Appl. No.: 13/577,538

(22) PCT Filed: Feb. 8, 2011
(86) PCT No.: PCT/ES2011/070082

§ 371 Date: Nov. 27, 2012

(30) Foreign Application Priority Data
Feb. 9, 2010 (ES) P201030174

(51) Int. Cl. B41J 25/308

(52) U.S. Cl. CPC B41J 25/3086
USPC 347/37

(57) ABSTRACT

The present invention relates to an adjustment system for adjusting the base of the print head of a plotter which includes means for adjusting the position of said base of the print head with respect to the printing base of the plotter, said base of the head comprising a substantially vertical fixed part (1) and a substantially horizontal adjustable part (2), and it is characterized in that said adjustment means comprise a substantially vertical rotating shaft (4) located between said adjustable part (2) and said fixed part (1); at least one substantially horizontal adjustment element (3) regulating the angular position of said adjustable part (2) with respect to said fixed part (1); and a plurality of substantially vertical adjustment elements (3) regulating the inclination and height of said adjustable part (2) with respect to said fixed part (1). It enables the base of the print head to be regulated easily and precisely, without any play.

The present invention relates to an adjustment system for adjusting the base of the print head of a plotter which allows adjusting the position of the base of the print head with respect to the printing base.

### BACKGROUND OF THE INVENTION

In plotters, placing print head or print heads in their correct position is of vital importance to achieve a correct plotting.

Particularly, the base on which the print heads are placed must be parallel with respect to the printing base on which the sheet material to be printed slides and the heads must also be perpendicular with respect the shaft on which they slide.

Today, the position of the base of the print head with respect to the printing base is directly adjusted with screws and adjustable parts.

This adjustment system for adjusting the base of the print head with respect to the printing base has the main drawback that a fine adjustment is complicated.

Therefore, there is an obvious need for an adjustment system for adjusting the base of the print head with respect to the printing base of a plotter which allows a fine and easy to perform adjustment without needing to be an expert.

### SUMMARY OF THE INVENTION

The adjustment system of the invention successfully solves the mentioned drawbacks, having other advantages which will be described below.

The adjustment system for adjusting the base of the print head of a plotter of the present invention comprising means for adjusting the position of said base of the print head with respect to the printing base of the plotter, said base of the head comprising a substantially vertical fixed part and a substantially horizontal adjustable part, characterized in that said adjustment means comprise:

a substantially vertical rotating shaft located between said adjustable part and said fixed part;

at least one substantially horizontal adjustment element regulating the angular position of said adjustable part with respect to said fixed part; and

a plurality of substantially vertical adjustment elements regulating the inclination and the height of said adjustable part with respect to said fixed part.

As a result of this feature, the base of the print head can be regulated easily and precisely, without any play.

According to a preferred embodiment, said adjustment elements are screws provided with a spring located around its shank.

The spring of said substantially vertical adjustment elements is preferably placed between a support provided in said fixed part and said adjustable part, and the spring of said substantially horizontal adjustment element is preferably placed between a support provided in said adjustable part and said fixed part.

### BRIEF DESCRIPTION OF THE DRAWINGS

To better understand the foregoing, several drawings are attached in which a practical case of embodiment is schematically depicted only by way of non-limiting example.

FIG. 1 is a perspective view of a base of the print head or print heads of a plotter provided with the adjustment system of the present invention; and

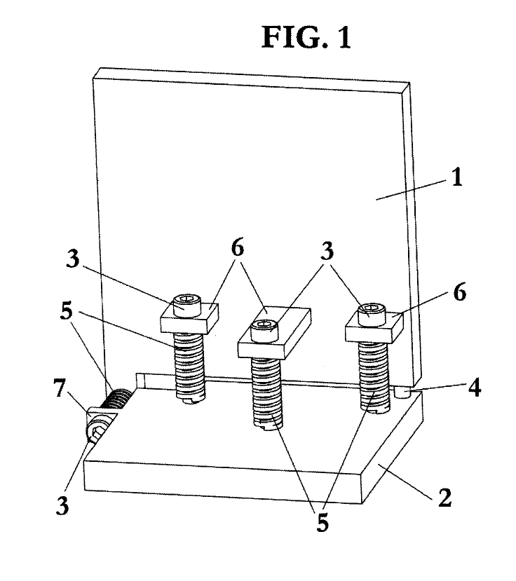

FIG. 2 is a perspective view similar to FIG. 1, in which the different adjustments which can be made by means of the adjustment system of the present invention are shown.

### DESCRIPTION OF A PREFERRED EMBODIMENT

As can be seen in the drawings, the base of the print head of a plotter comprises a substantially vertical fixed part 1 and a substantially horizontal adjustable part 2.

The adjustable part 2 can move vertically and angularly with respect to said fixed part 1. Furthermore, the inclination of the adjustable part 2 can also be adjusted with respect to the fixed part 1.

For the vertical adjustment and inclination, the adjustment system of the present invention comprises a plurality of adjustment elements 3, the embodiment depicted in the drawings have three adjustment elements, even though the adjustment elements could be of any suitable number.

For the angular adjustment, the adjustment system of the present invention comprises a substantially vertical rotating shaft 4 located between said adjustable part 2 and said fixed part 1, particularly at a corner of said adjustable part 2. Furthermore, the adjustment system of the present invention also comprises a substantially horizontal adjustment element 3 located between the fixed part 1 and the adjustable part 2.

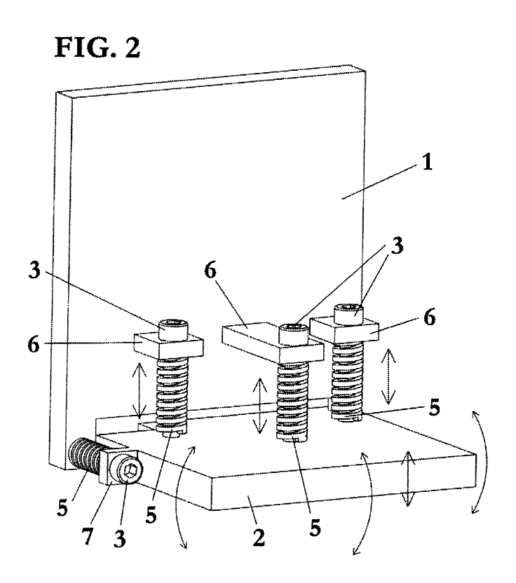

The arrows depicted in FIG. 2 shows the adjustments which can be made by means of the adjustment system of the present invention.

According to the depicted embodiment, said adjustment elements 3 are screws provided with a spring 5 located around its shank.

The spring 5 of said substantially vertical adjustment elements 3 is placed between a support 6 provided in said fixed part 1 and said adjustable part 2, whereas the spring 5 of said substantially horizontal adjustment element 3 is placed between a support 7 provided in said adjustable part 2 and said fixed part 1.

As seen in the drawings, said supports 6, 7 are located such that they are placed between the head of the screws 3 and the springs 5. Therefore, when a screw 3 is tightened, the spring 5 compresses, and when a screw 3 is loosened, the spring 5 decompresses.

The presence of the springs 5 also allows deforming the springs if they are pressed, but at the moment when pressure disappears, the springs 5 return the system to its previous position.

Despite that reference has been made to a specific embodiment of the invention, it is obvious for a person skilled in the art that the adjustment system described is susceptible to various variations and modifications, and that all the details mentioned can be substituted with other technically equivalent details without departing from the scope of protection defined by the claims attached.

1. An adjustment system for adjusting the base of the print head of a plotter, comprising a means for adjusting the position of said base of the print head with respect to the printing base of the plotter, said base of the head comprising a substantially vertical fixed part (1) and a substantially horizontal adjustable part (2), wherein the means for adjustment comprises:
a substantially vertical rotating shaft (4) located between said adjustable part (2) and said fixed part (1);
at least one substantially horizontal adjustment element (3) regulating the angular position of said adjustable part (2) with respect to said fixed part (1); and
a plurality of substantially vertical adjustment elements (3) regulating the inclination and the height of said adjustable part (2) with respect to said fixed part (1).

2. The adjustment system according to claim 1, wherein said adjustment elements (3) are screws provided with a spring (5) located around its shank.

3. The adjustment system according to claim 2, wherein the spring (5) of said substantially vertical adjustment elements (3) is placed between a support (6) provided in said fixed part (1) and said adjustable part (2).

4. The adjustment system according to claim 2, wherein the spring (5) of said substantially horizontal adjustment element (3) is placed between a support (7) provided in said adjustable part (2) and said fixed part (1).
